(19) United States
(12) Patent Application Publication
(10) Pub. No.: US 2026/0024011 A1
(43) Pub. Date: Jan. 22, 2026

(54) INTEGRATION FRAMEWORK FOR MULTIPLE MACHINE LEARNING MODELS

(71) Applicant: Tellagence, Inc., Oregon City, OR (US)

(72) Inventors: Nitin Mayande, Naperville, IL (US); Sharookh Daruwalla, Austin, TX (US)

(73) Assignee: Tellagence, Inc., Oregon City, OR (US)

(21) Appl. No.: 18/885,629

(22) Filed: Sep. 14, 2024

Related U.S. Application Data
(60) Provisional application No. 63/672,224, filed on Jul. 16, 2024.

(51) Int. Cl. G06N 20/00; G06F 16/903

(52) U.S. Cl. CPC G06N 20/00; G06F 16/90335

(57) ABSTRACT

An integration framework combines multiple machine learning (ML) models to provide an aggregated answer to a user query. The user query may be disambiguated and broken down into one or more simplified queries. These simplified queries are then analyzed to determine which of the ML models should be used to answer the queries, and an order in which the queries should be processed by the selected ML models is established. The queries are then processed through the selected ML models, and the responses are compiled into a final coherent answer. The answer may be checked for compliance with any relevant rules before being presented to the user and/or stored for further use. Other embodiments may be described and/or claimed.

### CROSS-REFERENCE TO RELATED APPLICATIONS

This application claims priority to U.S. Provisional Patent Application No. 63/672,224, filed on 16 Jul. 2024, the contents of which are hereby incorporated into this application by reference as if fully set forth herein.

### TECHNICAL FIELD

Disclosed embodiments are directed to machine learning (ML) systems, and in particular to frameworks for integration of multiple ML systems for responding to queries.

### BACKGROUND

Machine learning and Artificial intelligence (AI) technology continues to evolve into an increasingly useful tool that can be applied in a variety of different domains. ML systems include a wide variety of different types of algorithms that may enable a computer system to solve various problems, potentially in an adaptive fashion. ML systems may include statistical algorithms that can extrapolate patterns and/or general behaviors from specific data in a predictive fashion. AI technology, which is a subset or type of ML, includes a variety of different techniques and algorithms, including artificial neural networks (ANN). A subset of ANNs includes generative neural networks which, as the name suggests, can create various types of output based on an input prompt. Types of generative neural networks include large language models (LLMs), such as ChatGPT, and image generators, such as DALL-E, among others. For generally accessible implementations of generative AI systems such as ChatGPT and DALL-E, the systems are typically trained on vast amounts of data relevant to the AI system's operative modality, viz. text, images, etc., that may span a variety of different information domains. Other systems may be trained on more specific domains to form an expertise in a particular area. For example, some LLMs may be trained on social network data to provide predictive expertise on user behavior.

While the underlying implementations can vary, generative AI systems typically receive as input a query, such as a question in the form of one or more textual sentences (where the generative AI system input modality is text) or another appropriate input modality. The query is then fed into an input layer of the generative AI system. Generally speaking, generative AI systems are prediction engines, such that an answer to a query is generated by predicting what a next word, pixel, token, etc. (depending on the generative AI system output modality) would be based on the data set used to train the system and, in some implementations, previous predictions. Some generative AI systems also consider previous queries in providing answers, such as when a user has a “conversation” with the system, asking follow-up questions in response to predictions generated from earlier queries. As mentioned above, types of generative AI may include image generators, which can create synthetic images of widely different types based upon provided user prompts, as well as synthetic motion video. Some such generative AI can employ the likeness of existing people in creating entirely synthetic images and video. Still other examples of generative AI can include music generation, and multi-modal AI which may be able to generate a variety of different types of media in response to user prompts.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an example integrated framework system for multiple ML models, according to various embodiments.

FIG. 2 is a block diagram of the decode stage of the example system of FIG. 1, depicting the constituent components of the decode stage, according to various embodiments.

FIG. 3 is a block diagram of the route stage of the example system of FIG. 1, depicting the constituent components of the route stage, according to various embodiments.

FIG. 4 is a block diagram of the map stage of the example system of FIG. 1, depicting the constituent components of the map stage, according to various embodiments.

FIG. 5 is a block diagram of the execute stage of the example system of FIG. 1, depicting the constituent components of the execute stage, according to various embodiments.

FIG. 6 is a block diagram of the compilation stage of the example system of FIG. 1, depicting the constituent components of the writeback stage, according to various embodiments.

FIG. 7 is a flowchart of operations of an example method for processing a user query with multiple ML models using an integrated framework, according to various embodiments.

FIG. 8 is a block diagram of an example computer that can be used to implement some or all of the components of the disclosed systems and methods, according to various embodiments.

FIG. 9 is a block diagram of a computer-readable storage medium that can be used to implement some of the components of the system or methods disclosed herein, according to various embodiments.

### DETAILED DESCRIPTION

ML systems may be configured to accept input in a variety of different modalities, such as text, images, or sounds. Moreover, such ML systems may be capable of outputting in a modality that differs from the accepted input modalities. For example, a neural network trained and configured to output images may accept text-based prompts as input queries. Such a neural network could accept a text query to generate a picture of mountains and respond by outputting one or more such pictures that are responsive to the text query. Similarly, a neural network may be configured to accept an image as input, and output text information about the picture, such as describing one or more objects within the query image. In other examples, some ML systems may be capable of accepting and/or responding with multiple different modalities.

Just as ML systems may be configured to accept and/or respond in a variety of different modalities, ML systems likewise may be trained, configured, or otherwise optimized to respond to queries in a variety of different knowledge domains. For example, some ML systems may be designed or trained across a broad range of knowledge domains to enable them to answer general knowledge questions. ChatGPT, Google's Gemini, and Microsoft's Copilot, each based on a large language model (LLM), are three such examples of generative AI systems that have been trained to respond to general knowledge questions. Conversely, some ML systems may be configured or trained to respond to particular knowledge domains. An example of such a system would be a private AI system implemented for a company that is trained on specific company data, such as corporate policies, institutional knowledge, client data, etc., and so is capable of responding to queries that can be answered or extrapolated from the specific company data. Such an AI system may provide incorrect or non-sensical responses to questions not answerable from company data, or may simply be unable to supply an answer. Still further, some ML systems may naturally be limited in their responses based on their input and/or output modalities. For example, an AI system configured specifically to generate images, such as DALL-E, inherently cannot supply answers to queries that cannot be answered by way of a generated image.

User queries can take a variety of forms. In some cases, queries may be multi-modal and/or may be complex, viz. comprised of multiple related questions or overlapping concepts. Likewise, responses to some queries may best be presented with multiple modalities. Queries may implicate multiple knowledge domains that may require referencing local information, such as private corporate data, as well as more generalized information, to answer. For example, a business or organization may employ a generative AI system to solve business problems. The organization may also have a body of institutional knowledge relevant to their work or purpose, and this body of knowledge can form a context for a generative AI system. Absent this body of knowledge, the generative AI may provide answers to questions that are partially or wholly irrelevant to solving a given business problem and/or require a user to supply appropriate context with each interaction. However, these answers may be supplemented with responses from an ML or AI system that is trained on relevant business information.

It will be appreciated, then, that processing a given query through multiple different types of ML systems may yield a variety of different results which may provide relevant answers from a number of different perspectives and/or in multiple relevant modalities. These variety of perspectives/modalities collectively may result in a more comprehensive and/or complete answer to the query than if a single ML system was utilized, even if the single ML system is a general knowledge generative AI system. However, passing the same query through multiple ML systems and subsequently synthesizing a coherent answer, which may require disregarding various aspects of the collected answers that are less relevant and/or incorrect, can impose a significant time cost, particularly if the person submitting the query must synthesize the answer manually. A further burden may be realized if each answer from the various ML systems must be evaluated for accuracy and/or compliance with any relevant rules or regulations. This time cost may, in some cases, defeat any savings that was realized through the use of the ML systems.

Disclosed embodiments include a framework for integrating responses from multiple ML systems to a single query. Each of the multiple ML systems may be trained using different training sets and/or configured using differing techniques, and each may respond in a different modality. Further, each of the multiple ML systems may be configured to accept a query in different modalities. Integration frameworks according to various embodiments may allow for the creation of a collective of different ML systems that are capable of responding to queries in multiple modalities and/or across multiple knowledge domains in a more comprehensive fashion than a single ML system—even a general knowledge generative AI or LLM system—could respond.

Disclosed embodiments may accept as input a query from a user, process the query as necessary to break it into any constituent parts, determine which ML system or systems from the ML systems that are connected to the framework are best suited to answer the query (or its constituent parts), dispatch the query or its constituent parts to the selected ML system(s), then synthesize an answer to the query from the response(s) received from the ML system(s). Furthermore, some instances of the disclosed integration frameworks may be able to check an answer synthesized from the multiple ML systems for compliance with any applicable rules or regulations, to help avoid AI hallucinations and/or answers that fail to comply with any imposed restrictions or requirements. Other possible aspects and embodiments of the disclosed integration framework will be discussed herein.

As may be used herein, the term “local data” refers to any information that can form a context (regardless of whether used as such) for queries to a generative AI or ML system. Such information may include, but is not limited to, organizational databases, social media feeds, proprietary data regardless of format, data that may be relevant to an organization or user regardless of source, and the like. “Local” thus refers to relevance to a particular user, group of users, organization, or the like, as opposed to any random given user of the generative AI or ML system. “Local” is not being used herein in a geographic or physical locality sense.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

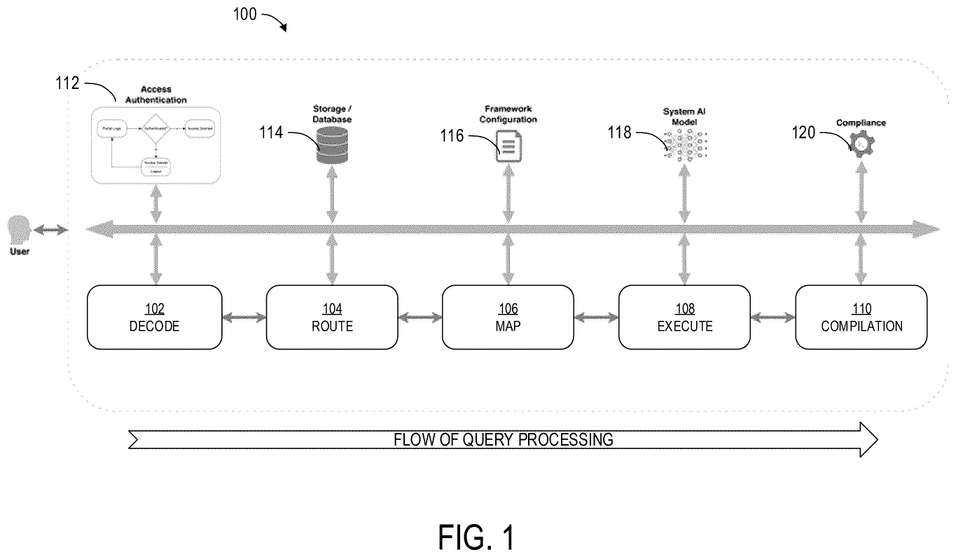

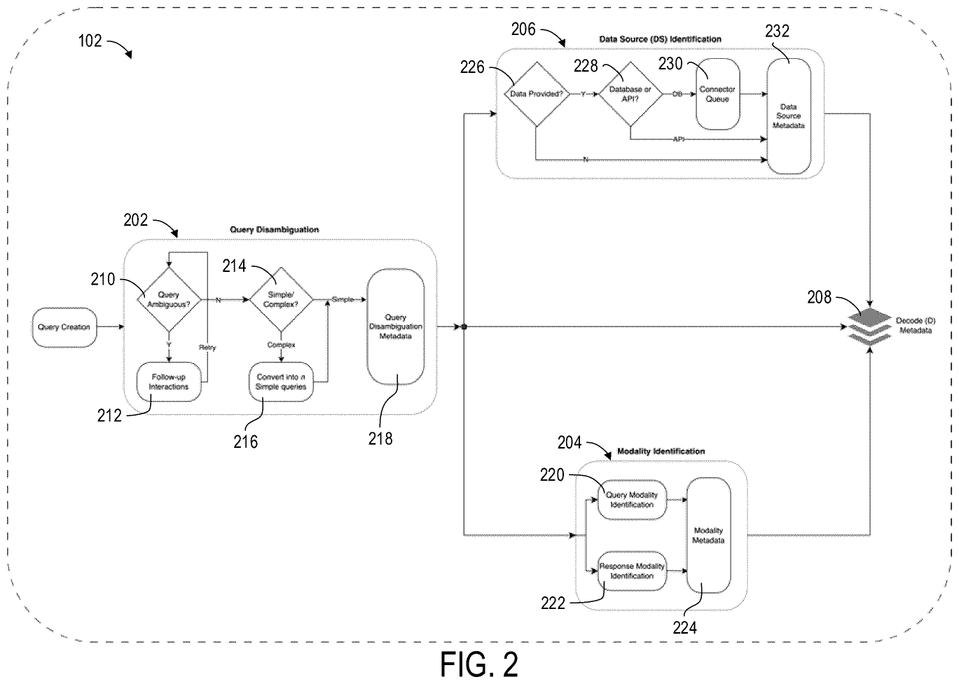

FIG. 1 is a block diagram of an example integration framework 100, according to some possible embodiments. Framework 100 may include five processing stages, which comprise a decode stage 102, a route stage 104, a map stage 106, and execute stage 108, and a compilation stage 110. In the illustrated example, a query may be received at the decode stage 102, and generally follows a processing flow from decode stage 102, to route stage 104, to map stage 106, to execute stage 108, and through to compilation (or write-back) stage 110. Each of the stages, as shown, may be in communication with its neighbors. This arrangement will be discussed further below with respect to FIGS. 2-6.

In addition to the various stages 102 to 110, framework 100 may include functional components such as access authentication 112, one or more storage or databases 114, a framework configuration 116, one or more system AI models 118, and compliance logic 120. Each of these components may be in communication and/or accessible by the various stages 102 to 110.

Access authentication 112, in embodiments, is a security module, logic, or apparatus that is responsible for ensuring that any needed authentications necessary to access the framework 100 and/or its various components are correctly supplied. These include, but are not limited to, access to the various stages within framework 100. For example, access authentication 112 may ensure a user is authorized not only to access the framework 100 in general, but also to access various data sources, learning models, outputs, and the like that are connected or otherwise utilized by framework 100. In some instances, access authentication 112 may restrict some portions of framework 100 if required by the entity implementing framework 100. Furthermore, access authentication 112 may maintain credentials for accessing any components that are external to framework 100, such as any ML systems that may be utilized by execute stage 108.

Storage/database 114 (hereinafter storage 114), in embodiments, may be generally accessible to the various components of framework 100. Storage 114 may be used to store any proprietary and/or confidential data securely, as well as store outputs from the ML models that are utilized by execute stage 108. In some instances, the storage 114 may be part of one or more of the various stages of framework 100. In other instances, storage 114 may be a general temporary or working storage that may be used exclusively for storage of any data generated or utilized by or with framework 100. In still other instances, storage 114 may include custom, local, and/or specific data sources to be used with the various ML models that are part of or attached to execute stage 108. It should be understood that storage 114 may be used to implement any or all of the foregoing.

Storage 114 may be implemented using one or more of any suitable storage technology, including one or more databases of suitable types, such as solid state storage, tape storage, disk storage, non-volatile storage, volatile/RAM storage, or the like. Storage 114 may be integrated as part of framework 100, such as local storage attached to a server or other computing device that implements part or all of framework 100, or may be separate and remotely accessible, such as cloud storage. In some embodiments, multiple storages 114 may be employed, with each potentially having a different function and/or configuration. For example, in implementations including multiple storages 114, some storages 114 may be integrated as part of framework 100 while others are external, and/or some storages 114 may be implemented as a database with others as unformatted or scratchpad type of storage, and the like.

Framework configuration 116 is a single point of storage for any preferences, settings, process flows, specific data sources, and/or any other configurable aspects or parameters of the framework 100, that need to be followed by the framework 100. They are used to customize framework 100 to the way an administrator or other person responsible for maintaining and/or configuration framework 100 would like or need it to function including, but not limited to, preferences for data sources (when there are multiple possible data sources), specific learning models to use for responding to various queries (such as for specific tasks), type of information to select in final outputs, and modality or modalities of the final output from framework 100, to name a few possible configurable aspects. The number and type of configurable aspects that may be controlled via framework configuration 116 may depend on the specifics of a given implementation of framework 100.

Framework configuration 116 may be implemented as one or more files of any suitable format for storing the various preferences, settings, etc., for framework 100. In some instances, framework configuration 116 may comprise text files, binary files, databases, XML files, or the like. Framework configuration 116 may be implemented using multiple files of differing formats, which may each store different configuration aspects, as the needs of a given implementation of framework 100 may require. In some instances, framework configuration 116 may be stored in storage 114.

System AI model 118 is used for some or all functions required for the proper functioning of the various stages of framework 100, including stages 102 to 110. Similar to the example of FIG. 1, in various embodiments model 118 may be separate from the various ML models connected to execute stage 108. In other embodiments, model 118 may be connected to execute stage 108 to be used in query processing. In some embodiments, model 118 may comprise a single model, while in other embodiments model 118 may comprise multiple ML models, which may be variously selected to perform any required or desired function(s) for framework 100. The type of ML model or models to be used as system AI model 118 may be any suitable ML model(s) that can perform any or all functions of framework 100 that may require or benefit from the functionality of the chosen model type(s) for model 118.

As mentioned above, in some instances the system AI model 118 may be within the library of models attached to execute stage 108 or, where multiple models are employed, none, some, or all of the models may be part of the library of models, and none, some, or all of the models may be separate from the library of models. System AI model 118 can be implemented using any suitable algorithm or algorithms (which may include, but need not be, one or more artificial neural networks) that meet the required functionality. Various functions of the stages 102 to 110 of framework 100, as well as other components of framework 100 such as access authentication 112 and/or compliance 120, may be accomplished by, or with the help of, model 118. Some possible examples of functionality that may be partially or wholly carried out with model 118 may include, but are not limited to: for decode stage 102, checking if a query is ambiguous, follow-up interactions with the user submitting a query, converting a complex query into multiple simple ones, and/or identifying the modality of a query and expected response; for route stage 104, query processing and related tasks, and/or data preparation and data processing; for map stage 106, assist in creation of a plan of execution to be carried out by the execute stage 108, and/or creating input prompts for models attached to execute stage 108; for compilation stage 110, identifying redundant/unique information within model outputs received from execute stage 108, and/or merging output information to create a coherent response to a query.

The primary function of compliance logic 120 is to verify the outputs of any or all of the various models connected to execute stage 108 and/or the final output that is displayed/stored in the compilation stage 110. This output verification may include, but is not limited to: accuracy/validity of the various outputs (e.g. detecting hallucinations), truthfulness of the outputs, legality of the outputs, and/or compliance with any rules and/or restrictions set by an administrator of framework 100. In some embodiments, such rules/restrictions may be set forth in or required by framework configuration 116. It should also be understood that compilation stage 110 may incorporate similar or complementary functionality in some instances, and/or may work in conjunction with compliance logic 120 to obtain a response that meets any applicable standards or requirements.

For example, an organization operating in or with a regulated space, such as finance or regulatory compliance, may need to ensure that any responses obtained from an ML system, such as a generative AI system, are in compliance with applicable regulatory requirements. Compliance logic 120 may accordingly be configured to assess output from the various ML systems attached to execute stage 108 for compliance with these regulatory requirements. If a given response fails to comply, compliance logic 120 may coordinate with other components of framework 100 to obtain a revised response that is compliant. In some embodiments, this compliance may be confirmed at least in part by utilization of system AI model 118. Example actions to bring the response into compliance may include, but are not limited to, revising any relevant prompt that is fed to applicable ML systems attached to execute stage 108 to generate a compliant response, providing feedback to a user supplying the initial prompt if the prompt is an improper request (e.g. the user has provided a query which inherently violates regulatory requirements), or any other suitable course of action.

The respective functions of these various components 112 to 120 as they relate to each of the stages 102 to 110 will be described below with respect to FIGS. 2-6.

Integration framework 100 and its constituent and associated components may be implemented using software, hardware, or a combination of both. Where framework 100 is implemented using hardware, the hardware may comprise one or more processors, discrete components, FPGAs, ASICs, a combination of the foregoing, and/or any other technology now known or later developed that is suitable for implementing the functionality of framework 100. Such hardware may be specifically configured to carry out some or all of the functionality of framework 100. Where one or more aspects are implemented using software, the various components of framework 100 may comprise one or more software modules or programs. In some instances, one or more of the various components of framework 100 may be implemented as standalone applications or processes, which may be in communication with other applications or processes, such as processes implementing other aspects of framework 100. Furthermore, the functionality of more than one component of framework 100 may be combined into a single application or process. In such implementations, the various components of framework 100 may only be logically distinct, rather than discrete software modules, programs, or files. As used here, “component” refers to any aspect of framework 100 including, but not limited to, any of stages 102 to 110.

Some instances of framework 100 may be deployed in a server or cloud-based environment, which may be remotely accessible and/or receive queries over a network from a device in communication with framework 100. Such an implementation may be accessible over a local area network, a wide area network, the Internet, or the like. Other instances may be deployed locally on a device, such as a desktop, laptop, tablet, smartphone, or other mobile computing device. In some instances, some functionality may be implemented locally on a device, with other functionality implemented remotely, such as on a server. For example, a mobile device may receive a query and handle some or all of the functions of the decode stage 102, then pass the information from the decode stage 102 to subsequent stages that are implemented on a cloud platform. In another example embodiment, a system may implement substantially all of the functionality of framework 100 except for one or more ML systems that are used to process queries as part of the execute stage 108, which may be hosted on a cloud platform and/or other remote systems. The execute stage 108 in such an implementation would then contact the remotely-hosed ML systems as necessary to respond to queries. Other arrangements of distributing the functionality of a given instance of framework 100 may be possible without departing from the scope of the disclosed invention.

FIG. 2 is a block diagram of the decode stage 102 of the example framework 100. Decode stage 102 receives as input a query from a user. The query may be single mode, e.g. text, image, or sound, or multi-mode, combining one or more input modes. The specific mode or modes that may be accepted for the query will depend upon the specifics of a given implementation of framework 100. As can be seen in FIG. 2, the query is initially received at query disambiguation block 202, then passed to modality identification block 204 and data source identification block 206. Finally, the results of the processing of blocks 202, 204, and 206 are written out as decode metadata 208, in embodiments. As will be discussed below, in some instances, modality identification block 204 and data source identification block 206 may receive processed results from query disambiguation block 202, rather than the unprocessed query from the user.

Query disambiguation block 202, in embodiments, is responsible for first checking if the query from the user is clear or ambiguous. An ambiguous query, as will be understood, may result in inaccurate and/or incomplete response(s) from the ML systems used in execute stage 108. Thus, disambiguation can help assure results that are most likely to be responsive to the query. Query disambiguation block 202 comprises an initial assessment 210 of whether the query is simple or complex. Ambiguity can be determined in any suitable way now known or later developed. In some instances, ambiguity may be determined using the AI/ML models that are part of or otherwise connected to the framework, such as system AI model 118. In other instances, one or more separate and/or dedicated ML algorithms may be employed, which may be incorporated as part of decode stage 102, execute stage 108, or another external ML system (not depicted). In some instances, one or more proprietary algorithms may be employed. If the query is deemed to be ambiguous, viz. initial assessment 210 results in a “yes”, the user is asked follow-up interactions 212 to remove the ambiguity. In various instances, these interactions may include, but are not limited to, generation of clarifying questions to present to the user, evaluation of relevant query context, such as previous user interactions, and/or evaluation of any local or organizational data relevant to the organization or entity implementing framework 100. Following these interactions, query disambiguation block 202 may iterate back to initial assessment 210, where the query is re-evaluated in light of or with the follow-up interactions. If ambiguities still remain, further follow-up interactions 212 may be asked. This process of assessments 210 and follow-up interactions 212 may iterate until assessment 210 determines that the query is no longer ambiguous.

Once the query is evaluated to be clear and precise, in embodiments, it proceeds to query breakdown logic. Within the query breakdown logic, the user query is first evaluated 214 to be either a simple query or a complex query. In various embodiments, a simple query is one where the query can be determined to be a self-contained query, e.g. types of basic questions such as who, what, when, and the like. In such embodiments, queries that do not fit into this self-contained nature are deemed to be complex queries. In other embodiments, what constitutes a simple vs. complex query may depend on the types of ML models that are attached to execute stage 108, such as what types of complexity a given ML model or set of models is capable of reliably processing without requiring further simplification. Framework configuration 116 may also indicate parameters for determining whether a query is simple or complex.

If determined to be complex, a complex query may then be broken down 216 into multiple simple queries, such as the self-contained queries described above. Evaluation and determination of whether the query is simple or complex may be carried out with any appropriate technique, such as using a suitably configured ML system. In some embodiments, the system AI model 118 may be employed to evaluate whether the query is simple or complex. In such embodiments, the system AI model 118 may be trained or otherwise configured to carry out such evaluations. For example, system AI model 118 may include a module or component that is specifically trained or configured to evaluate queries for complexity, and/or may further be capable of breaking down the query (if complex) and generating appropriate simple queries. As will be understood, the configuration of system AI model 118 in this respect may depend on the capabilities of the various ML models attached to execute stage 108, in various embodiments.

At the end of the query breakdown logic of evaluation 214 and break down 216, the resulting information may be stored as a query disambiguation metadata (QDM) 218. In some instances, the QDM 218 may include the final “sufficient” or modified query (if modification from the original query was necessary due to, e.g., subsequent or follow-up interactions 212), and, if the query was complex, each of the simplified queries into which the initial query was broken. Other metadata may be included, e.g. context for ambiguity resolution, as mentioned above. Where the query is determined to be unambiguous and simple, the QDM 218 may simply be the original query, possibly with any additional context or other information that may be required for a given implementation of framework 100. The format of QDM 218 may depend upon the specifics of the implementation of framework 100. In some embodiments, system AI model 118 or another suitable ML system may be capable of generating appropriate QDM 218.

Following query disambiguation block 202, the resultant metadata/query is processed through modality identification block 204 and data source identification block 206. Modality identification block 204 processes the user query to determine the modality of the query 220 as well as the expected modality of the response 222 (e.g. image, sound, text, etc.). As depicted in the example of FIG. 2, the modality identification block 204 may read and process the query disambiguation metadata 218 to work with the simplified and disambiguated query if appropriate and/or if such simplified data would result in a more accurate assessment of modality identification. In some instances, query modality identification 220 may only require determining the type or types of data submitted as the query, using any known or later developed method of data type identification. Similarly, in some instances determination or identification of response modality 222 may simply require reference to framework configuration 116, which may specify the response modality or modalities. Other instances may not require any determination of response modality 222, where framework 100 is configured to only respond with a single type of modality. In still other instances, determination of response modality (or modalities) 222 may require evaluation of the nature of the query, such as whether the query specifies a particular desired output modality (e.g. the query asks for the generation of an image or sound) and/or whether an answer to the query requires or otherwise would benefit from a specific modality or modalities. For example, some queries seeking analysis of data may benefit from a graphical depiction to supplement a textual response. In some such instances, framework configuration 116 may also indicate appropriate modalities for specific types or natures of queries. As with other aspects of decode stage 102, system AI model 118 may be configured to evaluate the query for the appropriate output modality or modalities. All the information related to query/response modality is stored within modality metadata 224.

Data source identification block 206 processes the user query to determine 226 if a specific data source needs to be accessed/used to process the query. As depicted in the example of FIG. 2, data source identification block 206 may read the query disambiguation metadata 218 in some instances, rather than the original query, where the simplified and disambiguated query is more appropriately used. In some instances, framework configuration 116 may specify one or more particular data sources to be used, either for all queries or for various specified types/classes/subject matter of queries. Such data sources may be provided as part of framework 100 or attached to framework 100, or, in some instances, such data sources may need to be located or otherwise connected to framework 100. In some embodiments, the data source may be part of storage 114, such as a corpus of data relevant to an entity that is implementing framework 100. In other embodiments, the data source may be external to framework 100, and/or may be one of a number of different possible data sources, the selection of which may be determined by the nature of the query. For example, if the query calls for domain-specific information, e.g. a query involving a specific technical field to provide proper context, then an appropriate data source to provide this context may be identified. In various instances, the query may be analyzed, such as by system AI model 118, to determine if a particular data source is needed.

If one or more data source(s) is/are to be utilized per determination 226, data source identification block 206 further determines specifics 228 related to accessing it, e.g. if it is private/public, accessed via API or database, etc. Where the data source is a database, data source identification block 206 may determine that a connection to the database must be established (if not previously connected). In some implementations, a database source may include a connector queue 230, and data source identification block 206 may be configured to initiate a connection to the connector queue 230, including possibly placing any requests into the queue 230 that may be necessary to prepare the data source for use by framework 100. Where the data source is accessed via an API, data source identification block 206 may determine and/or perform any necessary initiation to prepare the API for use. Once any necessary or desired data source is identified and possibly prepared, all information related to the data source or sources is stored within data source metadata 232.

Following processing by query disambiguation block 202, modality identification block 204, and data source identification block 206, the metadata resulting from each of these blocks, e.g. query disambiguation metadata 218, modality metadata 224, and data source metadata 232, may be combined into a single decode metadata 208. This decode metadata 208 may be used to communicate with subsequent stages of framework 100, in particular route stage 104. As with the other metadata, decode metadata 208 may be of any suitable format appropriate for a given implementation of framework 100. It should further be understood that, in some embodiments, decode metadata 208 may only be a logical association of query disambiguation metadata 218, modality metadata 224, and data source metadata 232; in such instances, reference to decode metadata 208 may rather be a direct reference to one of the three constituent metadata 218, 224, and/or 232.

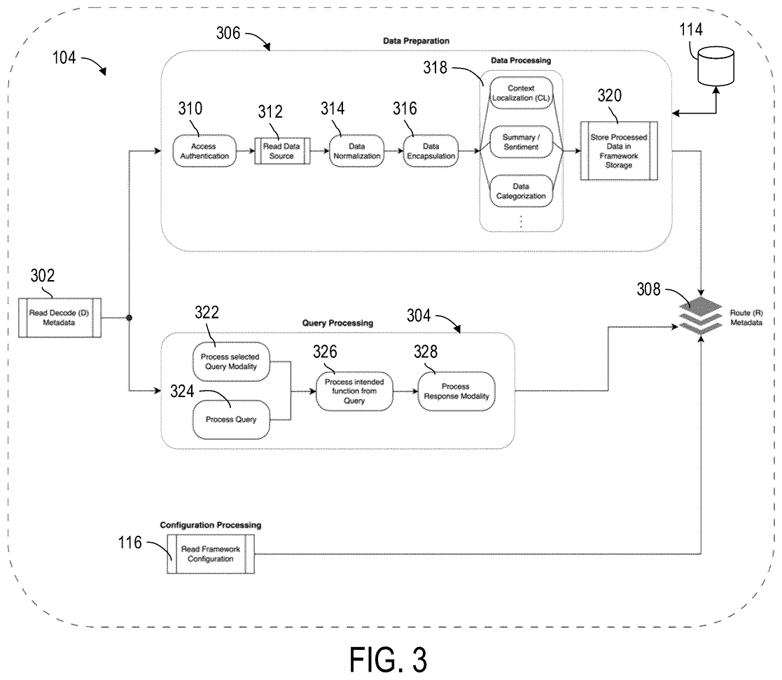

FIG. 3 is a block diagram of the route stage 104 of the example framework 100. In embodiments, route stage 104 begins by reading 302 the decode metadata 208 (FIG. 2) to utilize the information gathered by the decode stage 102. Route stage 104 also may read framework configuration 116, which may include any settings related to framework 100 that affect the functioning of route stage 104. In some embodiments, route stage 104 may further read information from execute stage 108, such as the list and capabilities/functionality of any attached ML systems. Route stage 104 is responsible for two main functions, query processing block 304 and data preparation block 306.

Query processing block 304, in embodiments, is responsible for further processing the query-related metadata that is part of the decode metadata 208. This includes processing the query 324 and query modality 322 (from the query modality identification 220 operation of FIG. 2) and expected response modalities 328 (from the determination of response modalities 222 operation of FIG. 2) to decide which learning models attached to execute stage 108 need to be utilized. As discussed above with respect to modality identification block 204 (FIG. 2), in some embodiments framework configuration 116 may specify input and/or output modalities, and so obviate the need for such processing. In other embodiments, the learning models needed may also be decided at least in part by the actual nature of the query itself, which may require processing 326 any set of simple queries indicated by the decode metadata 208 and/or determine the intended function of the original query. As with other stages and operations of framework 100, in some instances system AI model 118 or another suitable ML system may be employed to perform some or all of the analysis of query processing block 304. In embodiments, to determine which learning models of execute stage 108 are needed may require information from execute stage 108 as to the types and capabilities, e.g. accepted input modalities and output modalities, of each of the attached learning models.

Data preparation block 306, which may be utilized if a specific data source was identified by data source identification block 206 (FIG. 2) of decode stage 102, may access data from the identified data source and (pre-)process it for use with or by one or more of the learning models attached to execute stage 108. As seen in FIG. 3, data preparation block 306 may begin with access authentication 310 to verify that a given data source may be authorized by framework 100 and/or the user submitting the query. Access authentication 310 may, in embodiments, be carried out by, in cooperation with, or with support from, access authentication 112 (FIG. 1). The data source is then read 312, and preprocessing may be performed. Pre-processing may further include typical pre-processing actions such as data de-duplication, lemmatization, normalization 314, encapsulation 316, and the like,

Following pre-processing, data processing 318 may be carried out. Data processing 318 may include actions such as context localization (e.g., incorporation of data that is specifically relevant to an entity implementing a given instance of framework 100), summarization or sentiment analysis, more custom or proprietary techniques for data categorization or contextualization, and/or any other preparation steps that may be appropriate given the nature of a particular query and/or the requirements of subsequent stages of framework 100. The prepared/processed data may then be stored 320 into the storage 114 connected to the framework, as shown, or another suitable data storage or database.

The actual steps caried out by data preparation block 306 may vary depending on the specifics of a given instance, e.g. nature and type of data, and various ML models of execute stage 108 selected to respond to a given query. Different ML models may require different processing steps, and where more than one different ML model is to be used, several instances of data prepared with differing steps may be required. Moreover, in instances where framework 100 may need to interact with multiple different ML models to respond to a given query, and/or multiple specific data sources are identified as necessary, data preparation block 306 may execute differing steps for each of the different ML models on a given data, depending on which ML model or models that will be used to process the given data. In such instances, data preparation block 306, or more generally route stage 104, may be in communication with subsequent stages such as the map stage 106 and/or execute stage 108. In other possible embodiments, the various models attached to execute stage 108 may all need standard or common processing steps. In such embodiments, route stage 104 may only need to carry out a single set of pre-processing and/or processing steps to prepare the data for use with the ML models attached to execute stage 108.

Following completion of query processing block 304 and data preparation block 306, the results of each block may be written to a route metadata 308. Furthermore, as can be seen in FIG. 3, aspects or information from framework configuration 116 may be incorporated into or otherwise influence the structure of route metadata 308. As with the other metadata, route metadata 308 may be of any suitable format appropriate for a given implementation of framework 100.

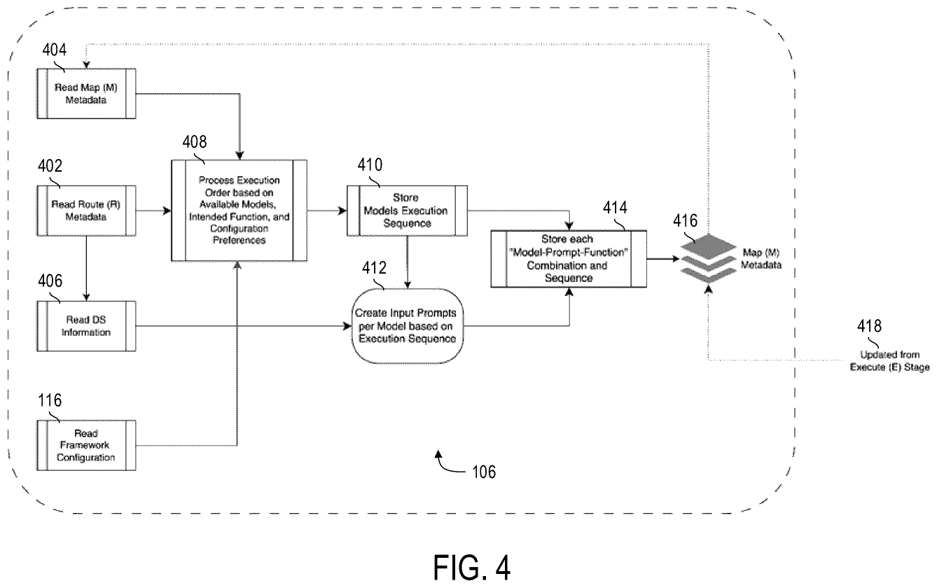

FIG. 4 is a block diagram of the map stage 106 of the example framework 100. Map stage 106, in embodiments, may perform several functions: 1) It may be responsible for processing all information resulting from decode stage 102 and route stage 104, and processing various information passed to it by execute stage 108, i.e., the various models connected to execute stage 108 for processing queries; and 2) it may be responsible for creating a clear and thorough plan-of-action for processing and obtaining an appropriate response to the query, including which models of execute stage 108 to use, the order in which they should execute, as well as if the models should execute in parallel or daisy-chain (i.e. use the output of one model as input to another).

Map stage 106 may first read various metadata files, including reading 402 route metadata 308 (FIG. 3) to determine the types of ML models that may be selected for query processing, reading 404 its own map metadata 416 to determine which ML models are connected to execute stage 108, and reading framework configuration 116 for any specific requirements and/or parameters that may be established for the operation of framework 100. Route metadata 308 may provide insight into the type of learning models needed to process the user query, i.e., query modality and response modality, along with which models can answer the query. In some instances, one or more ML models attached to execute stage 108 may be specialized for a particular topic or domain; this information may be supplied from query processing block 304 of FIG. 3, and inform decisions to be made by map stage 106 as to the order in which a query should be processed by execute stage 108. Route metadata 308 also may hold data source related information 406, such as from block 206 of FIG. 2, and more specifically data source metadata 232 (which may be incorporated into decode metadata 208 and subsequently passed through to route metadata 308), which may be used to craft and automate 412 the actual input prompts to be input by execute stage 108 to one or more ML models selected in the route stage 104 and map stage 106. Information from the data source specified in the data source related information 406, by way of the crafted input prompts 412 may be used to provide proper context localization for one or more of the selected ML models to ensure an accurate and relevant query answer.

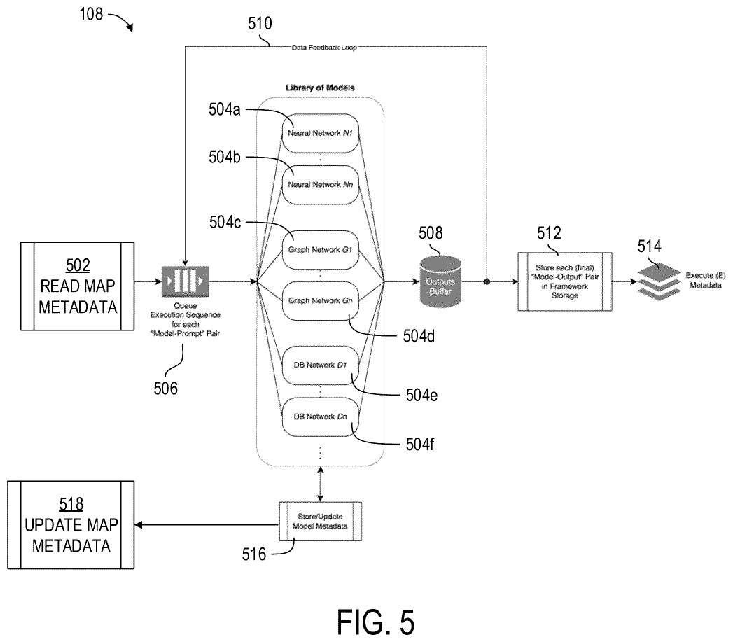

Map stage 106 also may read 404 its own map metadata 416. Map metadata 416 may include information tracking of all the various ML models connected to framework 100, and specifically to execute stage 108 (FIG. 5, models 504, discussed below). This information in map metadata 416 may be updated on a periodic basis. In some instances, execute stage 108 may update map metadata 416 directly, while in other instances map stage 106 may read relevant metadata from execute stage 108, such as stored model metadata. In still other instances, map stage 106 may query execute stage 108 in some other fashion to determine the attached ML models, or another appropriate portion of framework 100 that may store such information. This logical connection 418 from execute stage 108 is illustrated above in FIG. 4 and FIG. 5. Furthermore, map stage 106 may update its own metadata based on the logic, model(s), algorithm(s), and/or the like that were used by map stage 106 to respond to previous queries. Thus, map stage 106 may periodically/routinely/regularly read out the map metadata 416 to determine which ML models are presently connected and available to framework 100 in execute stage 108. Finally, as noted above, framework configuration 116 may be read to identify any settings related to map stage 106.

By processing 408 this information, including route metadata 308, map metadata 416, and framework configuration 116, map stage 106 may determine available ML models (along with their modal capabilities, knowledge base, etc.), the ML models that may have been selected in route stage 104 (as indicated in route metadata 308), any functions that may need to be performed to respond to a given query (including any simplified component queries that result from decode stage 102), and any preferential settings given within framework configuration 116, according to various embodiments.

With this information processed 408, map stage 106 may create and store a model execution order 410 for execute stage 108 to execute on the selected and indicated ML models. Once the execution order is created, map stage 106 may use the data source information 406 to create pertinent and useful prompts 412 that should be used to guide each learning model's execution. The model execution order 410 and input prompts 412, in embodiments, may be combined to create 414 a “Model-Prompt-Function” triplet information dataset in the order that execute stage 108 should process the query through the selected ML models. Each Model-Prompt-Function designates 1) what model is to be executed, with 2) what input prompt, and 3) what function the model is to perform. Once the Model-Prompt-Function sequence and dataset has been created, it may be stored within or otherwise as part of the map metadata 416, to be passed to execute stage 108.

As with the other metadata, map metadata 416 may be of any suitable format appropriate for a given implementation of framework 100. It should further be understood that map metadata 416 may combine the information, either directly or in a processed or digested form, resulting from the actions of both decode stage 102 and route stage 104, as provided from decode metadata 208 and route metadata 308, in embodiments. The decode metadata 208 may be passed to map stage 106 via inclusion (either directly or after processing or digestion) in route metadata 308. Thus, metadata, in various embodiments, is used as the means by which each stage passes the results of its actions through to subsequent stages.

FIG. 5 is a block diagram of the execute stage 108 of the example framework 100. In embodiments, execute stage 108 is where all the ML models are connected to framework 100. Execute stage 108 starts with reading 502 the map metadata 416, which may provide it with the execution order in the form of the Model-Prompt-Function triplet dataset. As it combines the results from decode stage 102, route stage 104, and map stage 106, map metadata 416 may include the initial query, either directly as provided by a user and/or in a series of simplified and disambiguated queries, as determined by decode stage 102, reference to any data source, input/response modality identification, necessary ML models specified from library of models 504a-504f, and processing sequence (the Model-Prompt-Function dataset in some embodiments), plus any additional information that may be required by a given implementation of framework 100.

In embodiments, the Model-Prompt-Function dataset in the map metadata 416 may be held inside a queue 506, which maintains the order for a Model-Prompt pair. When a Model-Prompt pair reaches the head of the queue 506, it is passed to the library of models 504a-504f (generically, model 504) for execution. In various instances, the library of models 504a-504f holds all the learning models connected to framework 100. As each Model-Prompt pair is processed from the queue 506, the prompt for each pair is passed to the specific model designated in the pair to obtain a response. The responses resulting from each Model-Prompt pair may then be stored in an output buffer 508 prior to further processing. The contents of output buffer 508, in embodiments, can then be re-routed 510 as an input for a subsequent Model-Prompt pair (which may be in the queue 506), if a dependency is expected or specified in the map metadata 416.

Furthermore, the Model-Prompt-Function triplet dataset may be organized to direct execute stage 108 to process the various prompts in a serial fashion or parallel fashion. When processed in serial, the output from a previous prompt may be fed back to the library of models 504a-504f, such as via re-routing 510. In some instances, the re-routing may serve as a subsequent prompt, while in other instances, the re-routing may be incorporated into a new prompt from queue 506, such as to form context for the new prompt. When processed in parallel fashion, several prompts from queue 506 may be dispatched to different models 504 where they can be answered via simultaneous processing. In still other scenarios, a combination of serial and parallel processing may be employed across various prompts as directed from the route stage 104 and map stage 106.

Output buffer 508 can hold more than one learning model output if needed, along with any necessary identification information (i.e. which execution order output or Model-Prompt-Function triplet with which the output is associated, etc.). If an output is not expected or needed to be used as an input via re-routing 510, or if it otherwise is to be used as provided from the executing model 504, then it may be stored 512 into the connected storage, such as storage 114, to be placed into execute metadata 514, for subsequent processing in writeback stage 110.

The models may be of a variety of different types. In the depicted example, models 504a and 504b are neural networks, models 504c and 504d are graph networks, and models 504e and 504f are database networks. It should be understood that the various models in the library of models 504a-504f are merely examples; the actual number and types of models will depend on the specific needs of a given implementation of framework 100. In various embodiments and as discussed above with respect to FIG. 4, whenever a new model is added to, altered, or deleted from the library of models, execute stage 108 may detect and update 516 stored model metadata, and may further update 518 map metadata 416. Alternatively, in other embodiments map stage 106 may directly query into the stored model metadata or library of models in lieu of execute stage 108 updating the map metadata 416.

As with the other metadata, execute metadata 514 may be of any suitable format appropriate for a given implementation of framework 100, and in addition to the results of the various models 504 used to process the Model-Prompts, may include information from the previous stages, viz. decode stage 102, route stage 104, and map stage 106.

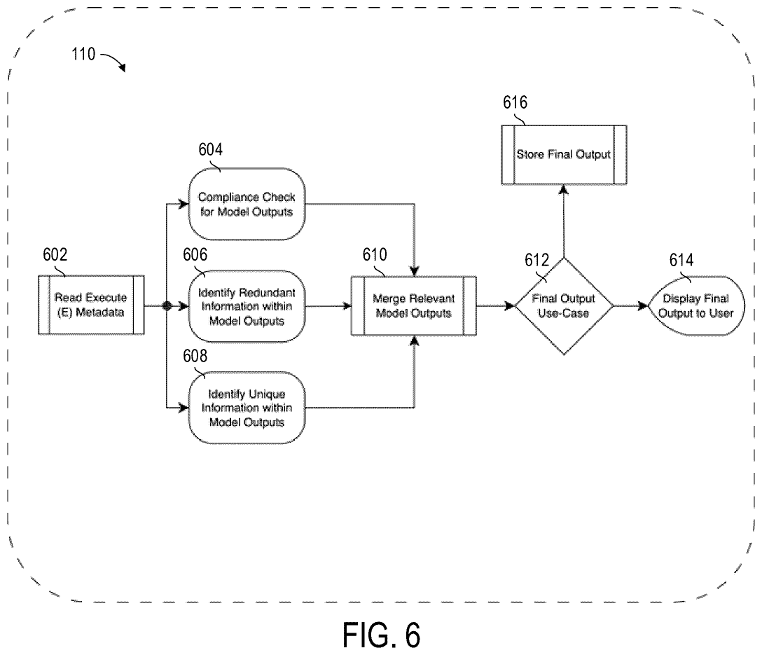

FIG. 6 is a block diagram of an example compilation stage 110 of the example framework 100. Example compilation stage 110, in embodiments, initially reads 602 the execute metadata 514 (FIG. 5), and may review the various outputs from the individual models 504. With these outputs, compilation stage 110 is responsible for: 1) Identifying 606 redundant information within the outputs from all the models 504 used; 2) Identifying 608 unique and relevant information within those outputs with respect or reference to the original user query; 3) Checking 604 the model outputs for any compliance rules set by the framework administrator (e.g. accuracy, legality, validity, etc.), which may have been established in compliance 120, discussed above with respect to FIG. 1; and 4) Merge 610 the relevant information from the outputs to create a coherent and applicable answer to the user query. In some instances, these checks may be performed by a compliance framework (such as compliance 120) which may be integrated into framework 100 or may be separate, depending on the needs of a specific embodiment.

Following reading of execute metadata 514 to obtain the individual final outputs from each of the models 504 used to answer the user query (as broken down and processed by decode stage 102 and other stages), checking the compliance of the output, and identifying the redundant/unique information present within the output, the information from the various model 504 outputs is then merged to form a coherent and applicable answer 612 to the original user query. This final output is then either displayed 614 back to the user of framework 100 as the response to their initial query and/or stored 616 into the framework storage 114, to use for any other purpose. The output may be presented in any suitable fashion to the user. Furthermore, the modality or modalities of the output may be as determined in modality identification 204 from decode stage 102.

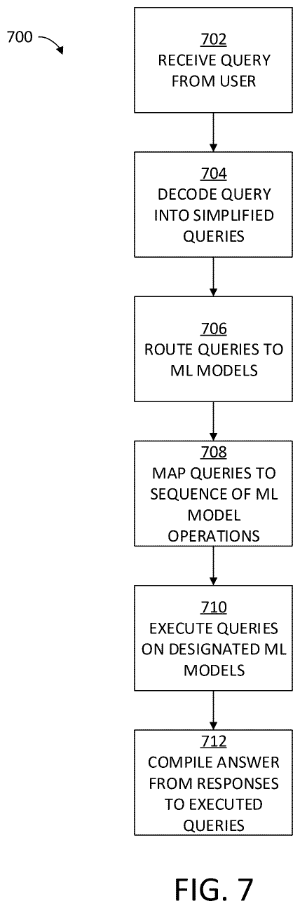

FIG. 7 is an example method 700 of the operations of an integration framework, such as the example integration framework 100 (FIG. 1). The operations of method 700 may be carried out in whole or in part, depending upon the needs of a given embodiment. Further, some operations may be omitted, some operations may be added, and the order of operations may be rearranged depending upon the requirements of a given embodiment. The operations of method 700 may be carried out by one or more components of the integration framework. Some or all operations may be carried out by a server, or by a device within the structure, or both. Much of the functionality described below in each operation corresponds with various blocks and modules described above with respect to FIGS. 1-6, and the reader is directed to the foregoing description of the same. Moreover, some aspects of a given operation may be instead carried out as part of a different operation, depending upon the specifics of a given implementing system.

In operation 702, in embodiments, a query is received from a user at a framework, such as framework 100. The query may be received in any suitable fashion for which the framework is configured, and further may be of any one or multiple modalities for which the framework is configured to accept.

In operation 704, in embodiments, the query may be disambiguated and/or decoded into one or more simplified queries, if the user query is determined to be complex. In various instances, the processing performed in operation 704 may reflect the processes performed by decode stage 102, and the reader is directed to the description of decode stage 102 found above with respect to FIG. 2.

In operation 706, in embodiments, the query or simplified queries, if the initial query was broken down, may be analyzed to determine the appropriate ML models to employ to answer the user query, and a routing may be generated indicating the ML models. In various instances, the processing performed in operation 706 may reflect the processes performed by route stage 104, and the reader is directed to the description of route stage 104 found above with respect to FIG. 3.

In operation 708, in embodiments, the query or simplified queries are mapped to the routed ML models to develop a sequence of operations, which may be expressed as one or more Model-Prompt-Function triplets, and may designate which prompts are to be executed in serial and/or in parallel. The query or simplified queries may be revised as necessary to reflect or incorporate any local data or other designated data source to provide proper context. In various instances, the processing performed in operation 708 may reflect the processes performed by map stage 106, and the reader is directed to the description of map stage 106 found above with respect to FIG. 4.

In operation 710, in embodiments, the query or simplified queries are executed on the various ML models as designated from the routing operation 706 and mapping operation 708, and in the sequence as designated from mapping operation 708. In various instances, the processing performed in operation 710 may reflect the processes performed by execute stage 108, and the reader is directed to the description of execute stage 108 found above with respect to FIG. 5.

In operation 712, in embodiments, the results from the executed query or simplified queries from operation 710 are compiled into a coherent answer to the original user query received in operation 702. Further, the answer may be analyzed for compliance with any applicable regulations, standards, and the like. The resulting answer may then be stored and/or presented to the original user who submitted the query in operation 702. In various instances, the processing performed in operation 712 may reflect the processes performed by compilation stage 110, and the reader is directed to the description of compilation stage 110 found above with respect to FIG. 6.

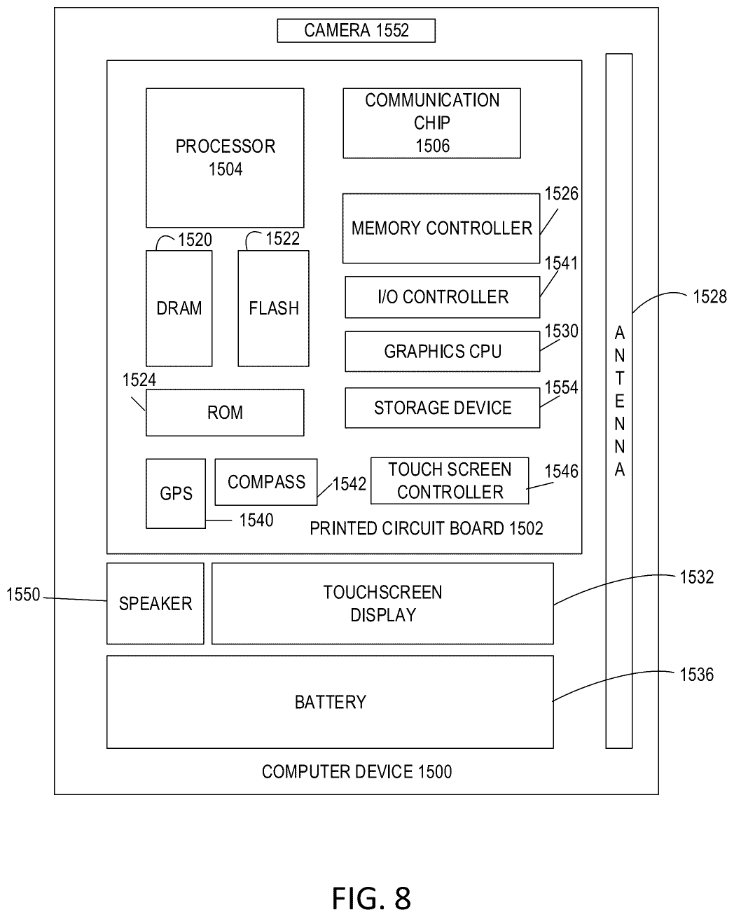

FIG. 8 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of system 100 or method 700 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

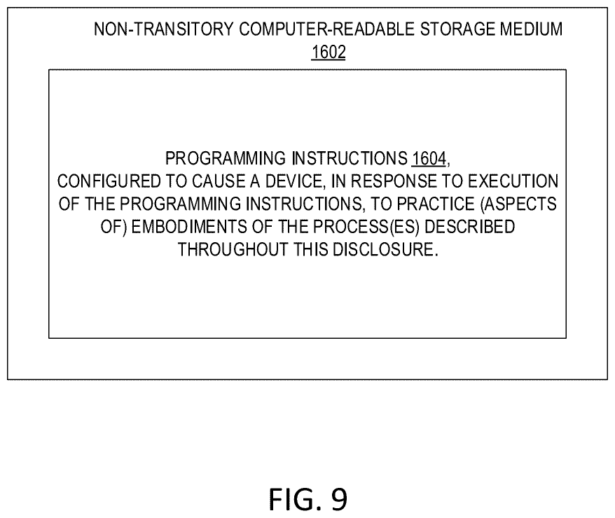

FIG. 9 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) system 100 or method 700, described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
receiving, at the server, a query;
decoding, by the server, the query into one or more simplified queries;
routing, by the server, the one or more simplified queries to one or more machine learning (ML) models;
mapping, by the server, each of the one or more simplified queries to determine a sequence of operations to be performed on the one or more ML models;
executing, by the server with the one or more ML models, the one or more simplified queries based on the sequence of operations to obtain one or more received responses; and
compiling, by the server, an answer to the query from the one or more received responses to the one or more simplified queries.

2. The method of claim 1, wherein decoding the query into one or more simplified queries comprises:
determining, by the server, whether the query is ambiguous;
resolving, by the server, any identified ambiguities;
determining, by the server, whether the query is complex; and
decomposing, by the server when the query is determined to be complex, the query into a plurality of simple queries, wherein the one or more simplified queries are comprised of the plurality of simple queries.

3. The method of claim 1, wherein routing the one or more simplified queries to the one or more ML models comprises:
determining, by the server, which types of ML models are needed based on a nature of the query; and
pre-processing, by the server, any specific data source identified as necessary to respond to the query.

4. The method of claim 1, wherein mapping each of the one or more simplified queries comprises:
selecting, by the server, which of the one or more ML models to use to process the one or more simplified queries;
when a plurality of the one or more ML models is selected to be used:
determining, by the server, the order in which the selected plurality of ML models should be used; and
determining, by the server, whether the selected plurality of ML models should be used in parallel or in serial; and
constructing, by the server, one or more prompts based at least in part on data source metadata to guide the selected one or more ML models.

5. The method of claim 1, wherein executing the one or more simplified queries comprises:
receiving, by the server, one or more model-prompt pairs that each correspond to one of the one or more simplified queries;
placing, by the server in turn, each of the one or more model-prompt pairs into a queue, the order of placement determined from the sequence of operations; and
executing, by the server in turn from the queue, each of the one or more model-prompt pairs with a corresponding one of the one or more ML models, wherein the corresponding ML model is designated by each respective model-prompt pair.

6. The method of claim 1, wherein compiling an answer to the query from the one or more received responses comprises:
checking, by the server, each of the one or more received responses for compliance with one or more rules; and
generating, by the server, a coherent response from all of the one or more received responses.

7. A non-transitory computer-readable medium (CRM) comprising instructions that, when executed by a processor of an apparatus, cause the apparatus to:
receive a query;
decode the query into one or more simplified queries;
route the one or more simplified queries to one or more machine learning (ML) models;
map each of the one or more simplified queries to determine a sequence of operations to be performed on the one or more ML models;
execute, with the one or more ML models, the one or more simplified queries based on the sequence of operations to obtain one or more received responses; and
compile an answer to the query from the one or more received responses to the one or more simplified queries.

8. The CRM of claim 7, wherein the instructions to cause the apparatus to decode the query into one or more simplified queries further cause the apparatus to:
determine whether the query is ambiguous;
resolve any identified ambiguities;
determine whether the query is complex; and
decompose, when the query is determined to be complex, the query into a plurality of simple queries, wherein the one or more simplified queries are comprised of the plurality of simple queries.

9. The CRM of claim 7, wherein the instructions to cause the apparatus to route the one or more simplified queries to the one or more ML models further cause the apparatus to:
determine which types of ML models are needed based on a nature of the query; and
pre-process any specific data source identified as necessary to respond to the query.

10. The CRM of claim 7, wherein the instructions to cause the apparatus to map each of the one or more simplified queries further cause the apparatus to:
select which of the one or more ML models to use to process the one or more simplified queries;
when a plurality of the one or more ML models is selected to be used:
determine the order in which the selected plurality of ML models should be used; and
determine whether the selected plurality of ML models should be used in parallel or in serial; and
construct one or more prompts based at least in part on data source metadata to guide the selected one or more ML models.

11. The CRM of claim 7, wherein the instructions to cause the apparatus to execute the one or more simplified queries further cause the apparatus to:
receive one or more model-prompt pairs that each correspond to one of the one or more simplified queries;
place, in turn, each of the one or more model-prompt pairs into a queue, the order of placement determined from the sequence of operations; and
execute, in turn from the queue, each of the one or more model-prompt pairs with a corresponding one of the one or more ML models, wherein the corresponding ML model is designated by each respective model-prompt pair.

12. The CRM of claim 7, wherein the instructions to cause the apparatus to compile an answer to the query from the one or more received responses further cause the apparatus to:
check each of the one or more received responses for compliance with one or more rules; and
generate a coherent response from all of the one or more received responses.

13. The CRM of claim 7, wherein the instructions are to further cause the apparatus to store, by each of decode, route, map, and execute, information into a corresponding metadata file which may be read by each of route, map, execute, and compile, respectively.

14. A system, comprising:
a data storage;
one or more processors; and
instructions stored on the data storage that, when executed by the one or more processors, cause the system to implement:
a decode module to decode a query into one or more simplified queries;
a route module to route the one or more simplified queries to one or more machine learning (ML) models;
a map module to map each of the one or more simplified queries to determine a sequence of operations to be performed on the one or more ML models;
an execute module to execute, with the one or more ML models, the one or more simplified queries based on the sequence of operations to obtain one or more received responses; and
a compile module to compile an answer to the query from the one or more received responses to the one or more simplified queries.

15. The system of claim 14, wherein the instructions to implement the decode module further cause the module to:
determine whether the query is ambiguous;
resolve any identified ambiguities;
determine whether the query is complex; and
decompose, when the query is determined to be complex, the query into a plurality of simple queries, wherein the one or more simplified queries are comprised of the plurality of simple queries.

16. The system of claim 14, wherein the instructions to implement the route module further cause the module to:
determine which types of ML models are needed based on a nature of the query; and
pre-process any specific data source identified as necessary to respond to the query.

17. The system of claim 14, wherein the instructions to implement the map module further cause the module to:
select which of the one or more ML models to use to process the one or more simplified queries;
when a plurality of the one or more ML models is selected to be used:
determine the order in which the selected plurality of ML models should be used; and
determine whether the selected plurality of ML models should be used in parallel or in serial; and
construct one or more prompts based at least in part on data source metadata to guide the selected one or more ML models.

18. The system of claim 14, wherein the instructions to implement the execute module further cause the module to:
receive one or more model-prompt pairs that each correspond to one of the one or more simplified queries;
place, in turn, each of the one or more model-prompt pairs into a queue, the order of placement determined from the sequence of operations; and
execute, in turn from the queue, each of the one or more model-prompt pairs with a corresponding one of the one or more ML models, wherein the corresponding ML model is designated by each respective model-prompt pair.

19. The system of claim 14, wherein the instructions to implement the compile module further cause the module to:
check each of the one or more received responses for compliance with one or more rules; and
generate a coherent response from all of the one or more received responses.

20. The system of claim 14, further comprising:
access authentication;
a framework configuration file to indicate preferences for any necessary data sources, specific ML models to use for specific query types, and the modality of compiled answer;
a system AI model; and
a compliance framework in communication with the compile module.
